(19) United States
(12) Patent Application Publication
(10) Pub. No.: US 2005/0110333 A1
(43) Pub. Date: May 26, 2005

(54) Spoked wheel having easily fixed spokes

(76) Inventor: Tseng Ping Tien, Taichung (TW)

Correspondence Address: Tseng Ping Tien, P.O. Box 63-298, Taichung, 40699, TW

(21) Appl. No.: 10/971,414

(22) Filed: Oct. 25, 2004

(30) Foreign Application Priority Data
Nov. 24, 2003 (TW) 92220712

(51) Int. Cl. B60B 1/02

(52) U.S. Cl. 301/58

(57) ABSTRACT

A spoked wheel includes a wheel rim having a number of orifices, a number of spokes to be secured to the wheel rim, a number of anchors including an enlarged head and an enlarged latch extended from the head and a reduced neck portion formed between the latch and the head, to engage into and retained in the orifices of the wheel rim. The latch includes one or more slits to allow the latch to be engaged into the orifices of the wheel rim. A number of fasteners each includes an enlarged base and a shank having an inner thread for threading with the spokes. The fastener is retainable in the anchor when the wheel rim is disposed up-side-down, to allow the spoke to be easily threaded to the shank of the fastener, and to secure the fastener to the anchor.

### BACKGROUND OF THE INVENTION

1. Field of the Invention

The present invention relates to a spoked wheel, and more particularly to a spoked wheel having a number of spokes that may be easily and quickly and solidly secured to a wheel rim of the spoked wheel.

2. Description of the Prior Art

Various kinds of typical spoked wheels have been developed and comprise a number of spokes to be secured to a wheel rim of the spoked wheel with various kinds of fasteners, latches, or other securing devices.

For example, U.S. Pat. No. 5,806,935 to Shermeister discloses a tension-lock system for spokes in spoked wheels, including a nipple having both internal threads and external threads, and a number of spokes having external threads for threading with the internal threads of the nipple. However, the nipple may not be solidly secured to the wheel rim when the spokes have not been suitably threaded into the nipple.

U.S. Pat. No. 6,048,035 to Chen discloses a typical bicycle rim for a spoked wheel, including an annular frame having a connecting member fitted in the annular frame, and having a number of spokes for threading and securing to the annular frame with spoke fasteners. However, the spoke fasteners ay not be easily engaged through the annular frame and may not be used to quickly secure the spokes to the annular frame.

U.S. Application Publication No. US 2003/0209936A1 to Chen discloses a typical spoke engaging structure for tubeless rims, including a tubeless rim having a number of elongate apertures formed or defined through an inner part thereof, and a number of spokes each having an elongate head for inserting through the elongate apertures of the tubeless rim, and for rotating 90 degrees relative to the tubeless rim, in order to secure the heads of the spokes in the rim. However, the heads of the spokes may be easily disengaged from the rim inadvertently, particularly when assembling the spokes to the rim.

The present invention has arisen to mitigate and/or obviate the afore-described disadvantages of the conventional spoked wheels.

### SUMMARY OF THE INVENTION

The primary objective of the present invention is to provide a spoked wheel including a number of spokes that may be easily and quickly and solidly secured to a wheel rim of the spoked wheel.

In accordance with one aspect of the invention, there is provided a spoked wheel comprising a wheel rim including a number of orifices formed in an inner peripheral portion thereof, a number of spokes to be secured to the wheel rim, a number of anchors for securing the spokes to the wheel rim, each anchor including an enlarged head having an outer diameter greater than an inner diameter of the orifices of the wheel rim, to prevent the head from moving through the orifices of the wheel rim. Each anchor includes an enlarged latch extended from the head and having an outer diameter greater than the inner diameter of the orifices of the wheel rim, and includes a reduced neck portion formed between the latch and the head and having an outer diameter smaller than the inner diameter of the orifices of the wheel rim, to allow the reduced neck portion of the anchor to be engaged into and retained in the orifices of the wheel rim, the latch of each anchor includes at least one slit formed therein, to increase a resilience of the latch, and to allow the latch to be engaged into the orifices of the wheel rim, the anchor includes a chamber formed in the latch and an aperture formed in the head, and a number of fasteners each includes an enlarged base for engaging into the chamber of the anchor, and a shank extended from the base for engaging into the aperture of the anchor, and the shank includes an inner thread formed therein, for threading with the spokes, and for allowing the fasteners to be detachably secured to the spokes. The latch is engageable into the orifice of the wheel rim, and the fastener is retainable in the chamber of the anchor and has the base and the shank engaged into the chamber and the aperture of the anchor respectively when the wheel rim is disposed up-side-down, and the spoke may then be threaded to the shank of the fastener, to secure the fastener in the aperture and the chamber of the anchor, and to solidly secure the anchor and the spoke to the wheel rim.

The wheel rim includes a peripheral channel formed therein and defined between the inner peripheral portion and an inner peripheral partition thereof, to receive the latch and the fastener. A distance between the inner peripheral portion and the outer peripheral partition of the wheel rim is smaller than an addition of lengths of the fastener and the latch of the anchor, to allow the fastener to be retained in the chamber of the anchor, and to prevent the fastener from being disengaged from the anchor after the latch has been engaged into the orifice of the wheel rim.

The anchor includes a peripheral shoulder formed between the reduced neck portion and the latch, to anchor and position the reduced neck portion of the anchor in the respective orifice of the wheel rim.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a spoked wheel in accordance with the present invention;

FIG. 2 is a partial exploded and partial cross sectional view of the spoked wheel;

FIG. 3 is a partial cross sectional view of the spoked wheel; and

FIGS. 4, 5 are partial cross sectional views similar to FIG. 3, illustrating the operation of the spoked wheel.

### DETAILED DESCRIPTION OF THE PREFERRED EMBODIMENT

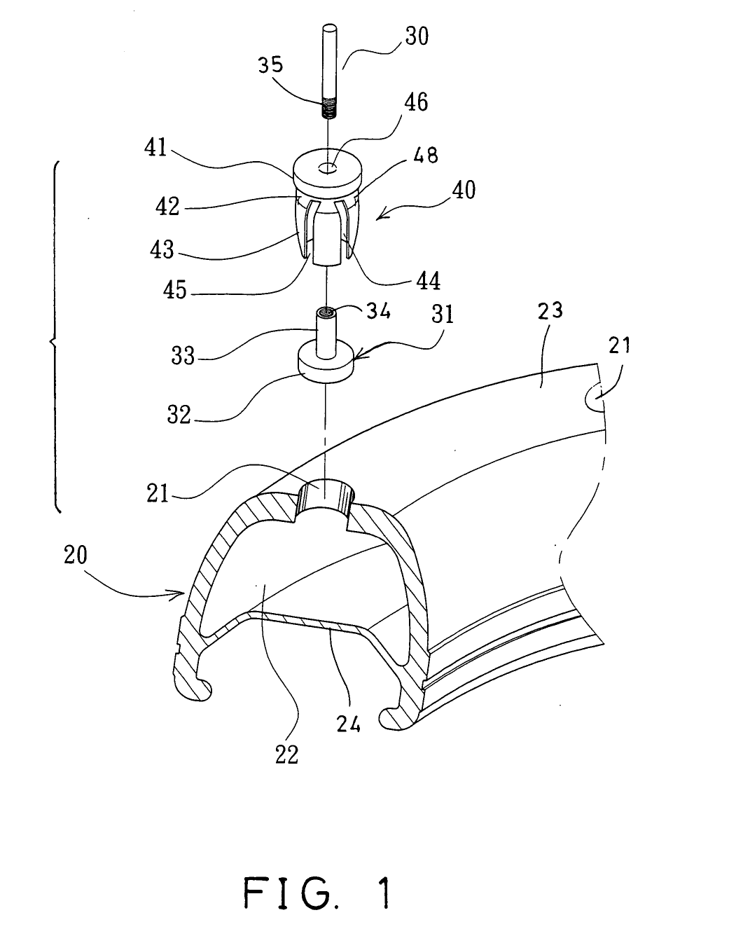

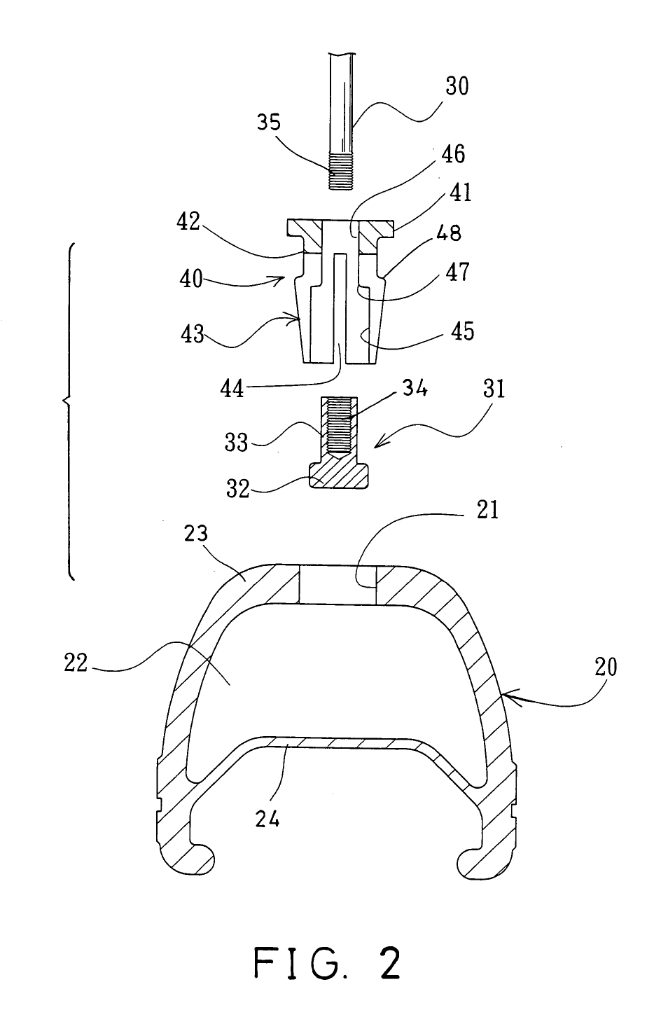

Referring to the drawings, and initially to FIGS. 1-3, a spoked wheel in accordance with the present invention comprises an annular or peripheral wheel rim 20 including a number of orifices 21 formed in an inner peripheral portion 23 thereof, and an annular or peripheral channel 22 formed in the wheel rim 20 and defined between the inner peripheral portion 23 and an outer peripheral partition 24 thereof.

A number of spokes 30 are provided to be secured to the wheel rim 20 with a number of fasteners 31, and each of the fasteners 31 includes an enlarged base 32, and a shank 33 extended from the base 32 and having an inner thread 34 formed or provided therein, for threading with an outer thread 35 that is formed in a free end portion of each spoke 30, and thus for allowing the fasteners 31 to be releasably or detachably secured to the spokes 30.

The spoked wheel further includes a number of anchors 40 for easily and quickly and solidly secured the spokes 30 to the wheel rim 20 of the spoked wheel. Each of the anchors 40 includes an enlarged head 41 having an outer diameter greater than an inner diameter of the orifices 21 of the wheel rim 20, for preventing the head 41 from moving through the orifices 21 of the wheel rim 20, and thus for anchoring or securing the anchors 40 to the wheel rim 20.

Each anchor 40 further includes an enlarged latch 43 extended from the head 41, and having an outer diameter greater than the inner diameter of the orifices 21 of the wheel rim 20, and a diameter reduced neck portion 42 formed between the latch 43 and the head 41, and having an outer diameter smaller than the inner diameter of the orifices 21 of the wheel rim 20, to allow the reduced neck portion 42 of the anchor 40 to be engaged into and retained in the respective orifices 21 of the wheel rim 20.

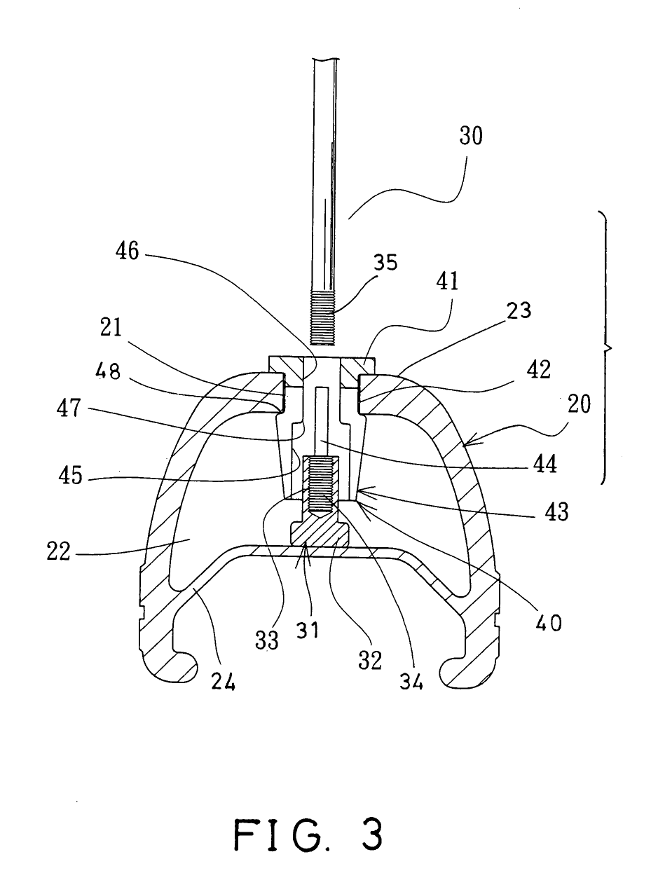

The latch 43 includes one or more slits 44 formed therein, to increase a resilience or a flexibility of the latch 43, and to allow the latch 43 to be engaged into and retained in the respective orifices 21 of the wheel rim 20 that include an inner diameter smaller than the outer diameter of the latch 43 (FIG. 3), such that the latches 43 may be easily attached and secured to the wheel rim 20.

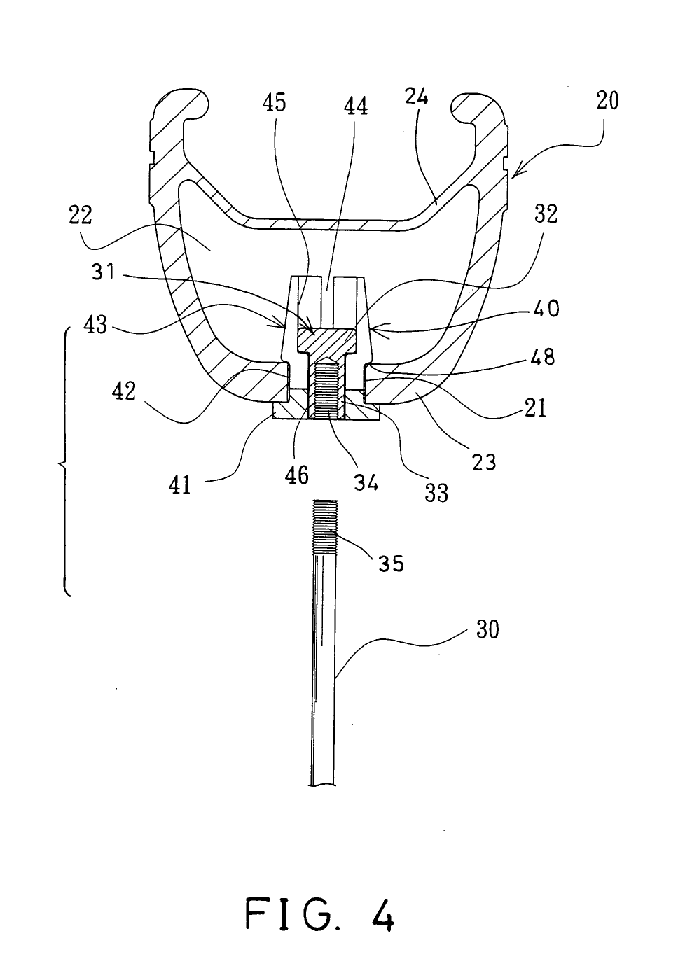

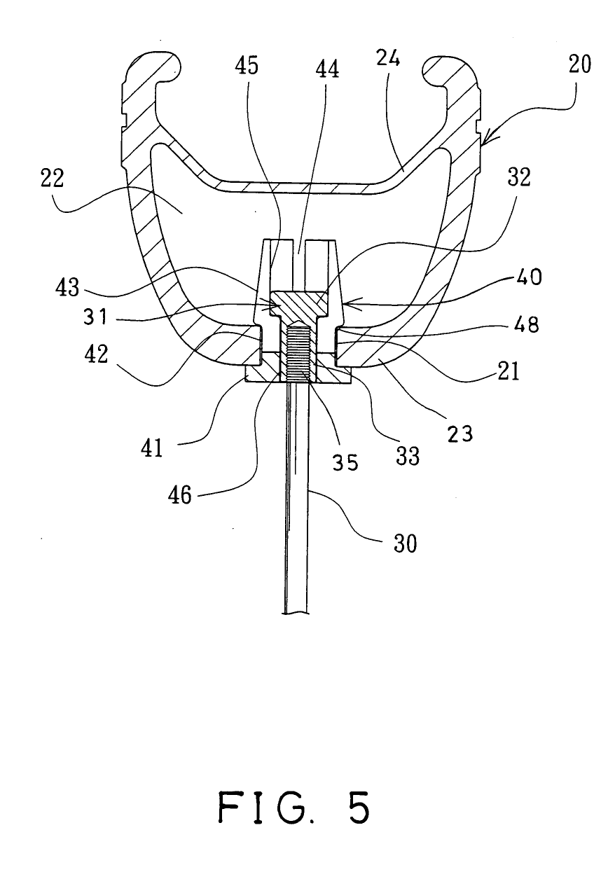

The latch 43 of the anchor 40 includes a chamber 45 formed therein for receiving the base 32 of the fastener 31, the anchor 40 further includes an aperture 46 formed in the head 41 and/or in the reduced neck portion 42 thereof for receiving the shank 33 of the fastener 31, and the aperture 46 of the anchor 40 includes an inner diameter smaller than that of the chamber 45 of the anchor 40, in order to form a peripheral shoulder 47 between the aperture 46 and the chamber 45 of the anchor 40, and to anchor or position the fastener 31 in the aperture 46 and the chamber 45 of the anchor 40 (FIGS. 4, 5).

It is also preferable that a peripheral shoulder 48 is formed or provided between the reduced neck portion 42 and the latch 43 of the anchor 40, to anchor or position the reduced neck portion 42 of the anchor 40 in the respective orifices 21 of the wheel rim 20 (FIGS. 3-5), and to prevent the head 41 and the latch 43 from moving through the orifices 21 of the wheel rim 20, and thus to anchor or secure the anchors 40 to the wheel rim 20.

As shown in FIG. 3, it is preferable that the depth of the channel 22 of the wheel rim 20, or the distance between the inner peripheral portion 23 and an outer peripheral partition 24 of the wheel rim 20 is smaller than an addition of both lengths of the fastener 31 and the latch 43 of the anchor 40, to allow the fastener 31 to be retained or confined in the chamber 45 of the anchor 40, and to prevent the fastener 31 from being disengaged from the anchor 40 after the latch 43 has been engaged into the orifice 21 of the wheel rim 20.

In operation, as shown in FIG. 3, the latch 43 may be easily and quickly engaged into the orifice 21 of the wheel rim 20, and may have the fastener 31 to be retained or confined in the chamber 45 of the anchor 40. As shown in FIG. 4, the wheel rim 20 may then be disposed up-side-down, to have the shank 33 of the fastener 31 to be engaged into the aperture 46 of the anchor 40 and to have the base 32 of the fastener 31 to be engaged into the chamber 45 of the anchor 40.

The outer thread 35 of the spoke 30 may then be threaded to the inner thread 34 of the fastener 31, as shown in FIG. 5, to secure the fastener 31 in the aperture 46 and the chamber 45 of the anchor 40, and thus to solidly secure the anchor 40 and the spoke 30 to the wheel rim 20. It is to be noted that the base 32 of the fastener 31 is engaged in the chamber 45 of the anchor 40, such that the latch 32 may not be folded or deformed or bowed or bent, and such that the anchor 40 may not be disengaged from the wheel rim 20 at this engagement or position.

Accordingly, the spoked wheel in accordance with the present invention includes a number of spokes that may be easily and quickly and solidly secured to a wheel rim of the spoked wheel.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A spoked wheel comprising:
a wheel rim including a plurality of orifices formed in an inner peripheral portion thereof,
a plurality of spokes to be secured to said wheel rim,
a plurality of anchors for securing said spokes to said wheel rim, each anchor including an enlarged head having an outer diameter greater than an inner diameter of said orifices of said wheel rim, to prevent said head from moving through said orifices of said wheel rim,
each anchor including an enlarged latch extended from said head and having an outer diameter greater than said inner diameter of said orifices of said wheel rim, and including a reduced neck portion formed between said latch and said head and having an outer diameter smaller than said inner diameter of said orifices of said wheel rim, to allow said reduced neck portion of said anchor to be engaged into and retained in said orifices of said wheel rim,
said latch of each anchor including at least one slit formed therein, to increase a resilience of said latch, and to allow said latch to be engaged into said orifices of said wheel rim, said anchor including a chamber formed in said latch and an aperture formed in said head, and
a plurality of fasteners each including an enlarged base for engaging into said chamber of said anchor, and a shank extended from said base for engaging into said aperture of said anchor, and said shank including an inner thread formed therein, for threading with said spokes, and for allowing said fasteners to be detachably secured to said spokes,
said latch being engageable into said orifice of said wheel rim, and said fastener being retainable in said chamber of said anchor and having said base and said shank engaged into said chamber and said aperture of said anchor respectively when said wheel rim is disposed up-side-down, and said spoke being threaded to said shank of said fastener, to secure said fastener in said aperture and said chamber of said anchor, and to solidly secure said anchor and said spoke to said wheel rim.

2. The spoked wheel as claimed in claim 1, wherein said wheel rim includes a peripheral channel formed therein and defined between said inner peripheral portion and an inner peripheral partition thereof, to receive said latch and said fastener.

3. The spoked wheel as claimed in claim 2, wherein a distance between said inner peripheral portion and said outer peripheral partition of said wheel rim is smaller than an addition of lengths of said fastener and said latch of said anchor, to allow said fastener to be retained in said chamber of said anchor, and to prevent said fastener from being disengaged from said anchor after said latch has been engaged into said orifice of said wheel rim.

4. The spoked wheel as claimed in claim 1, wherein said anchor includes a peripheral shoulder formed between said reduced neck portion and said latch, to anchor and position said reduced neck portion of said anchor in said respective orifice of said wheel rim.
